(19) United States
(12) Patent Application Publication
(10) Pub. No.: US 2014/0143708 A1
(43) Pub. Date: May 22, 2014

(54) Desktop Switching Method And Device

(71) Applicant: TENCENT TECHNOLOGY (SHENZHEN) COMPANY LIMITED, Shenshen (CN)

(72) Inventors: Guang YANG, Shenzhen (CN); Zhuomeng LI, Shenzhen (CN); Yong PENG, Shenzhen (CN); Xinqiu XIE, Shenzhen (CN); Hongjie LIU, Shenzhen (CN)

(73) Assignee: TENCENT TECHNOLOGY (SHENZHEN) COMPANY LIMITED, Shenzhen (CN)

(21) Appl. No.: 14/147,781

(22) Filed: Jan. 6, 2014

Related U.S. Application Data
(63) Continuation of application No. PCT/CN2012/078169, filed on Jul. 4, 2012.

(30) Foreign Application Priority Data
Jul. 6, 2011 (CN) 201110188336.1

(51) Int. Cl. G06F 3/0481

(52) U.S. Cl. CPC G06F 3/0481
USPC 715/778

(57) ABSTRACT

A desktop switching method and device, the method including generating a first desktop window; configuring the first desktop window according to a relevant relationship between the first desktop window and a second desktop window; and performing desktop switching according to a current desktop window and the relevant relationship between the first desktop window and the second desktop window. The device includes a framework entrance module, a dock bar and a desktop manager.

### CROSS-REFERENCE TO RELATED APPLICATIONS

This application is a continuation of International Application No. PCT/CN2012/078169, filed on Jul. 4, 2012. This application claims the benefit and priority of Chinese patent application No. 201110188336.1, filed on Jul. 6, 2011. The entire disclosures of each of the above applications are incorporated herein by reference.

### FIELD

The present disclosure relates to a computer field and to a desktop switching method and device.

### BACKGROUND

This section provides background information related to the present disclosure which is not necessarily prior art.

With the popularity of the computer, more and more people are using the computers. The computer is regarded as one of the necessary tools in people's daily life.

For most users, the desktop of the Operating System (OS) is the most convenient operation entrance. The user creates or pastes application icons, such as software icons and files on the desktop. Then, the user may activate software and open the files via clicking on the software icons and files on the desktop. Over time, the desktop becomes more and more chaotic. Most normal users don't know how to clear the desktop, resulting in plenty of desktop management software. The desktop management software acts as desktop edition software. The user may manage the desktop with the desktop management software, such as edit or classify the software icons and files on the desktop.

### SUMMARY

This section provides a general summary of the disclosure, and is not a comprehensive disclosure of its full scope or all of its features.

In order to solve the problem in the prior art, various embodiments provide a desktop switching method and device. The technical scheme is as follows.

A desktop switching method includes:

generating a first desktop window;

configuring the first desktop window according to a relevant relationship between the first desktop window and a second desktop window; and

performing desktop switching according to a current desktop window and the relevant relationship between the first desktop window and the second desktop window.

A desktop switching device includes:

a framework entrance module, to generate a first desktop window and configure the first desktop window according to a relevant relationship between the first desktop window and a second desktop window; and

a desktop manager, to perform desktop switching according to a current desktop window and the relevant relationship between the first desktop window and the second desktop window.

A non-transitory computer-readable medium storing instructions which, when executed by one or more processors, executes steps in the above method.

The technical scheme provided by various embodiments brings the following technical effects.

The first desktop window is generated, and is configured according to the relevant relationship between the first desktop window and the second desktop window. The desktop switching is performed according to the current desktop window and the relevant relationship between the first desktop window and the second desktop window. Therefore, the switching between the two desktop windows is implemented, and the user may select a suitable desktop according to his/her requirements and use the applications in the desktop.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. One with ordinary skill in the art may obtain other figures with these accompanying figures without creative work.

FIG. 1 is a schematic diagram illustrating an illustrative running environment of a desktop management system in accordance with various embodiments;

FIG. 2 is a schematic diagram illustrating a frame platform in accordance with various embodiments;

FIG. 3 is a flow chart illustrating a desktop switching method in accordance with various embodiments;

FIG. 3a is a flow chart illustrating another desktop switching method in accordance with various embodiments;

FIG. 4 is a schematic diagram illustrating information interaction, in which an application is loaded in accordance with various embodiments;

FIG. 5 is a schematic diagram illustrating structure of a desktop switching device in accordance with various embodiments;

FIG. 5a is a schematic diagram illustrating structure of a desktop switching device in accordance with various embodiments; and

FIG. 6 is a schematic diagram illustrating structure of a desktop switching device in accordance with various embodiments;

FIG. 7 is a schematic diagram illustrating structure of a desktop switching device in accordance with the various embodiments.

Corresponding reference numerals indicate corresponding parts throughout the several views of the drawings.

### DETAILED DESCRIPTION

Example embodiments will now be described more fully with reference to the accompanying drawings to make the objective, technical solution and merits thereof more apparent.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

Various embodiments provide a desktop management system. An architecture diagram of an illustrative running environment of the system is shown in FIG. 1. The system includes a data serving module 101, a framework platform 102, and an application extension module 103.

The framework platform 102 creates a framework of a first desktop window. The first desktop window in this disclosure may be a Q+ desktop window, a Google desktop window, a Yahoo desktop window, or a Sina desktop window, etc. The framework platform 102 further displays an interface according to data provided by the data serving module 101, provides an Application Programming Interface (API) of this platform to the application extension module 103 to implement various applications, loads an application, manages a desktop, and makes a desktop switching between the first desktop window and a second desktop window. The second desktop window may be an OS desktop window such as a Windows desktop window or a Linux desktop window.

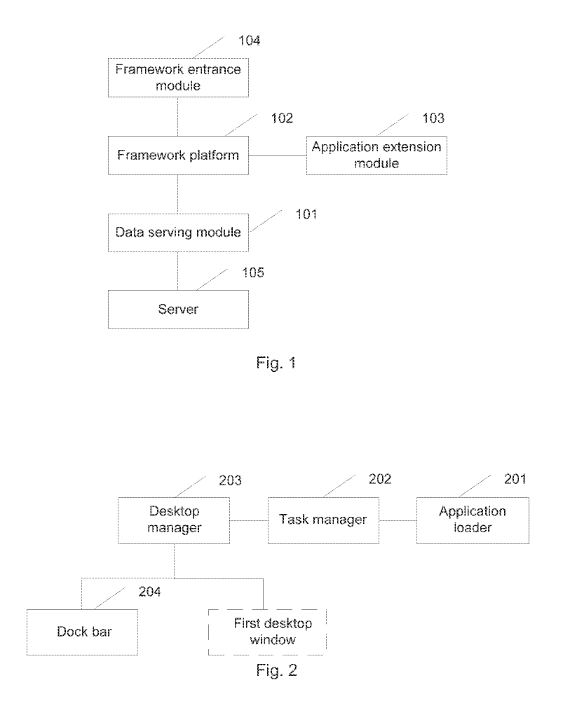

Referring to FIG. 2, the framework platform 102 shown in FIG. 1 may include an application loader 201, a task manager 202, a desktop manager 203, a dock bar 204, and the first desktop window (such as the Q+ desktop window, Google desktop window, Yahoo desktop window, or the Sina desktop window, etc.).

The application extension module 103 implements each application with the API provided by the framework platform 102. Each application has an application ID. Each application is registered in the framework platform 102 and the application may be used in the framework platform 102.

The system further includes a framework entrance module 104 and a server 105.

The data serving module 101 provides a data access interface to the framework platform 102, interacts with the server 105, such as writing data into the server 105 and reading data from the server 105 and synchronizing data with that in the server 105. With the data serving module 101, data of the user is stored in the server 105, by which the roaming of the user data may be implemented.

The framework entrance module 104 is responsible for processing initialization, loading, startup, and exit operation of the whole framework and is further responsible for controlling a software singleton, parsing a command line parameter and updating software, etc. The framework entrance module 104 may be the entrance of the first desktop window (such as the Q+ desktop window, Google desktop window, Yahoo desktop window, or the Sina desktop window, etc.). The server 105 is responsible for the authentication of the user, the storage and the RAN of the user data and so on.

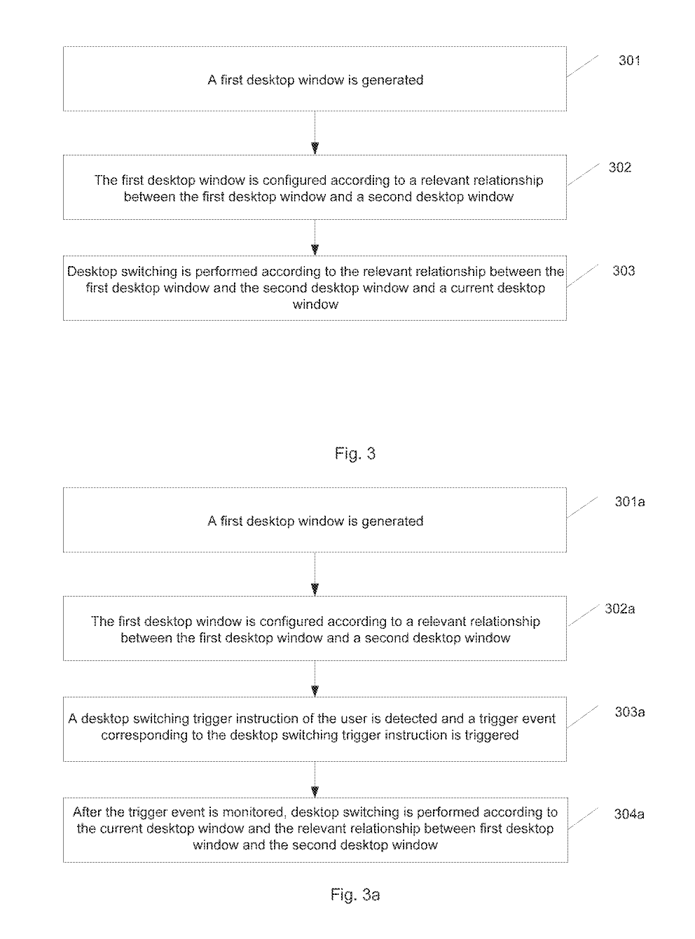

FIG. 3 is a flow chart illustrating a desktop switching method in accordance with various embodiments.

Referring to FIG. 3, the method includes the following blocks.

In block 301, a first desktop window is generated.

In block 302, the first desktop window is configured according to a relevant relationship between the first desktop window and a second desktop window.

In block 303, desktop switching is performed according to the relevant relationship between the first desktop window and the second desktop window and a current desktop window.

Based on the above system, various embodiments provide another desktop switching method. Referring to FIG. 3a, the method includes the following blocks.

In block 301a, a first desktop window is generated.

This block may be executed by a framework entrance module. For instance, when a new desktop generation function is triggered in the desktop management software (such as, the Q+ desktop window, Google desktop window, Yahoo desktop window, or the Sina desktop window), this block 301a is executed.

In block 302a, the first desktop window is configured according to a relevant relationship between the first desktop window and a second desktop window.

The relevant relationship between the first desktop window and the second desktop window may be configured by a user in advance based on requirements. Preferably, the relevant relationship may be edited. For instance, the relevant relationship between the first desktop window and the second desktop window may be configured so that the first desktop window and the second desktop window are coordinative desktop windows in advance. Alternatively, the first desktop window may be configured as the sub-window of the second desktop window in advance. In various embodiments, the relevant relationship between the first desktop window and the second desktop window may be stored in the desktop management software in advance. Then, the framework entrance module obtains the relevant relationship from the desktop management software and configures the first desktop window based on the relevant relationship.

The above processing may be executed by the framework entrance module. Various embodiments provide at least two configuration methods.

In the first configuration method, the relevant relationship between the first desktop window and the second desktop window is configured as the coordinative relationship. The first configuration method may include blocks a1 and a2 and may further include blocks a3 and a4.

At block a1, the first desktop window is configured as a top-level window.

The first desktop window is configured as the top-level window by configuring a parent window of the first desktop window as NULL.

The following processing may be performed on the first desktop window.

A title attribute of the first desktop window is removed and a window client area is kept. A tool window attribute is added and display of a window taskbar is removed. The size of the first desktop window is configured as that of a screen window.

At block a2, a configuration that the first desktop window covers the second desktop window and is under an ordinary window corresponding to an application program is made.

The method for making the first desktop window cover the second desktop window includes configuring the order of the first desktop window and the second desktop window with a function for configuring the order of windows. The function designates a window which needs to be configured as the first desktop window. An order that the first desktop window is on the top of the second desktop window and under the ordinary window corresponding to the application program is configured in the function. The function for configuring the order of the windows may be different according to the types of the first desktop window and the second desktop window. This disclosure does not make limitation on the function for configuring the order of the windows.

If the second desktop window is the Windows desktop window and the first desktop window is the Q+ desktop window, Google desktop window, Yahoo desktop window or the Sina desktop window, the following function may be adopted.

SetWindowPos

(hQ PlusWindow, HWND_BOTTOM, 0,0, width, height, 0);

The first parameter denotes a window handle. In various embodiments, the first parameter is the first desktop window. In various embodiments, the first desktop window is hQPlusWindow, i.e. the Q+ desktop window. The second parameter is an order handle. In various embodiments, the second parameter is HWND_BOTTOM, denoting placing the window at the bottom of the Z order. Furthermore, the function may include other parameters. The third parameter and the fourth parameter respectively denote a horizontal coordinate and a vertical coordinate. The fifth parameter and the sixth parameter respectively denote width and height. The seventh parameter denotes a window positioning ID.

The ordinary window corresponding to the application program may be the QQ+ desktop window, the OS application window, Google desktop window, Yahoo desktop window or the Sina desktop window, etc.

At block a3, a configuration that the first desktop window returns a MA_NOACTIVATE message when the first desktop window responds to a window message of the first desktop window is made. Therefore, when the user activates the first desktop window, the first desktop window is still under the ordinary window and cannot be activated to relocate on top of the ordinary window.

At block a4, a configuration that all sub-controls on the first desktop window are drawn and non-windows. Therefore, when the user activates a sub-control of the first desktop window, the first desktop window is still under the ordinary window and cannot be activated to relocate on top of the ordinary window.

It should be noted that the all sub-controls on the second desktop window may be windows.

In the second configuration method, the method for configuring the first desktop window as the sub-window of the second desktop window includes blocks b1 and b2.

At block b1, the second desktop window is found.

The second desktop window may be found with a window finding function or may be found with the sub-window of the second desktop window. The method for finding the second desktop window with the sub-window of the second desktop window includes finding a window with the window finding function, determining whether the sub-window of the second desktop window is the sub-window of the found window, determining that the found window is the second desktop window if yes, and terminating the finding process; otherwise, continuing to find the window with a window function which has a specific relationship with the designated window, performing the above determination until the second desktop window is found and terminating the finding process.

The second desktop window may be a Windows desktop window, a Linux desktop window or other OS desktop windows. Generally, the name of the OS desktop is Progman. The second desktop window may be found with the following methods.

In Windows XP, the OS desktop may be found with FindWindow(“Progman”, NULL).

In Windows 7, there is a window named WorkerW and supporting a dynamic background. It is easy to confuse this window with the real OS desktop. There is a sub-window named SHELLDLL_DefView on the real OS desktop. The sub-window is for displaying shortcut icons. The method for finding the real OS desktop is as follows.

Block 1: HWND hWnd=FindWindow(“Progman”, NULL). It is determined whether the SHELLDLL_DefView is the sub-window of the hWnd. The finding process is terminated if yes; otherwise, block 2 is performed.

Block 2: hWnd=GetWindow(hWnd, GW_HWNDNEXT). It is determined whether the SHELLDLL_DEFView is the sub-window of the hWnd. The finding process is terminated if yes; otherwise, block two continues.

The FindWindow function returns a window handle of the top-level window of the window class name or window name matching with a designated character string. The function does not find the sub-window. The GetWindow function returns a window handle having a specific relationship (such as the Z order or owner) with the designated window.

At block b2, the first desktop window is configured as the sub-window of the second desktop window.

The first desktop window is configured as the sub-window of the second desktop window with a handle of the second desktop window.

The user may set different application icons in the first desktop window and the second desktop window according to requirements of the user, so that the user may activate different applications in different desktop windows. It may be configured that all the applications or partial applications in the first desktop window and the second desktop window are the same.

At block 303a, a desktop switching trigger instruction of the user is detected and a trigger event corresponding to the desktop switching trigger instruction is triggered.

The above operation at block 303a may be executed by a dock bar. The dock bar may float at any position on the screen, such as the top, bottom, the left-most or right-most side of the screen and simultaneously locates the first desktop window (such as the Q+ desktop window, Google desktop window, Yahoo desktop window, or the Sina desktop window, etc.) and the second desktop window (such as the Windows desktop window, Linux desktop window, or other OS desktop windows).

The desktop switching trigger instruction may be a click operation, a movement operation or retention time, etc. Various embodiments do not make limitations on the desktop switching trigger instruction.

In various embodiments, the corresponding relationship between the desktop switching trigger instruction and the trigger event may be configured in advance. After the desktop switching trigger instruction of the user is detected, the dock bar may trigger the trigger event corresponding to the desktop switching trigger instruction. For instance, the corresponding relationship between the desktop switching trigger instruction, such as the click operation, movement operation or retention time and a desktop switching trigger event may be configured. After the trigger instruction, such as the click operation, movement operation or retention time is detected, the trigger event corresponding to the detected desktop switching trigger instruction may be determined and the trigger event is triggered.

At block 304a, after the trigger event is monitored, desktop switching is performed according to the current desktop window and the relevant relationship between first desktop window and the second desktop window.

The operation at block 304a may be executed by a desktop manager.

As for the first configuration method, the relationship between the first desktop window and the second desktop window is the coordinate relationship. That is, the first desktop window and the second desktop window are coordinative desktop windows.

After the trigger event is monitored, a first desktop screenshot and a second desktop screenshot are captured. The first desktop screenshot and the second desktop screenshot are combined to form a screenshot. It is determined whether the current desktop window is the second desktop window. If the current desktop window is the second desktop window, the second desktop disappears in an animation mode or a window desalination mode and the first desktop window is displayed in the animation mode or a window pop-up mode. Alternatively, if the current desktop window is the first desktop window, the first desktop window disappears in the animation mode or the window desalination mode and the second desktop window is displayed on the second desktop window in the animation mode or the window pop-up mode.

As for the second configuration method, when the first desktop window is the sub-window of the second desktop window, the process for switching the desktops includes:

determining whether the current desktop window is the second desktop window after the trigger event is monitored and displaying the first desktop window on the top of the second desktop window if yes. The first desktop window may display on the top of the second desktop window by covering the second desktop window. If the current desktop window is the first desktop window, the first desktop window is hidden and the second desktop window is displayed.

At block 304a, after the switching operation is performed and the first desktop window is displayed, the method may further include a block of loading an application in the first desktop window.

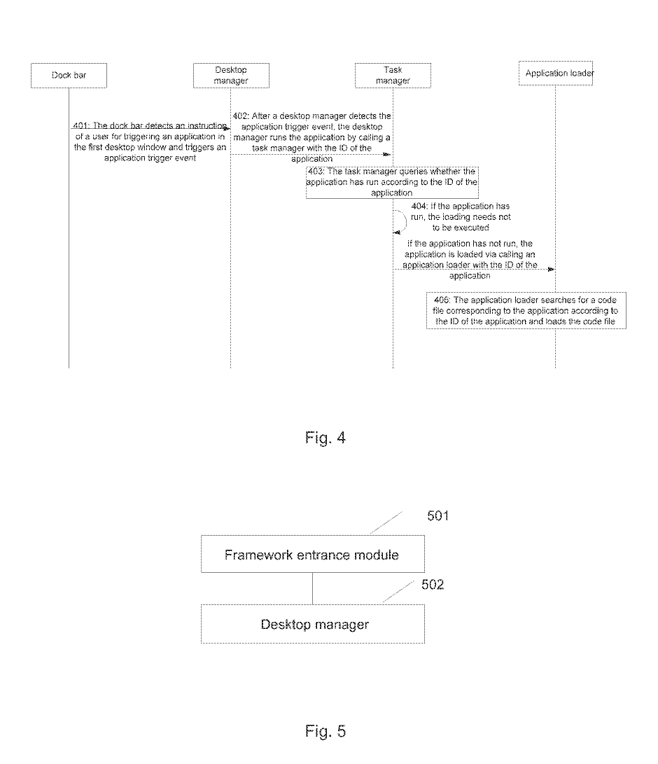

Referring to FIG. 4, FIG. 4 includes blocks 401 to 406.

At block 401, a dock bar detects an instruction of a user for triggering an application in the first desktop window and triggers an application trigger event. For instance, the application trigger instruction may be a click operation, a movement operation or a retention time and the trigger event may be a desktop switch trigger event.

At block 402, after a desktop manager detects the application trigger event, the desktop manager runs the application by calling a task manager with the ID of the application.

At block 403, the task manager queries whether the application has run according to the ID of the application. Block 404 is executed is yes; otherwise, block 405 is executed.

At block 404, if the application has run, the application needs not to be loaded again and block 406 is executed.

At block 405, if the application has not run, the application is loaded via calling an application loader with the ID of the application.

At block 406, the application loader searches for a code file corresponding to the application according to the ID of the application and loads the code file.

In various embodiments, the first desktop window is generated, the first desktop window is configured according to the relevant relationship between the first desktop window and the second desktop window, the desktop switching trigger instruction of the user is detected, the trigger event is triggered according to the desktop switching trigger instruction and the desktop switching is performed according to the current desktop window and the relevant relationship between the first desktop window and the second desktop window. Therefore, the switching between the two desktop windows is implemented, the user may select a suitable desktop according to his/her requirements and use the applications in the desktop.

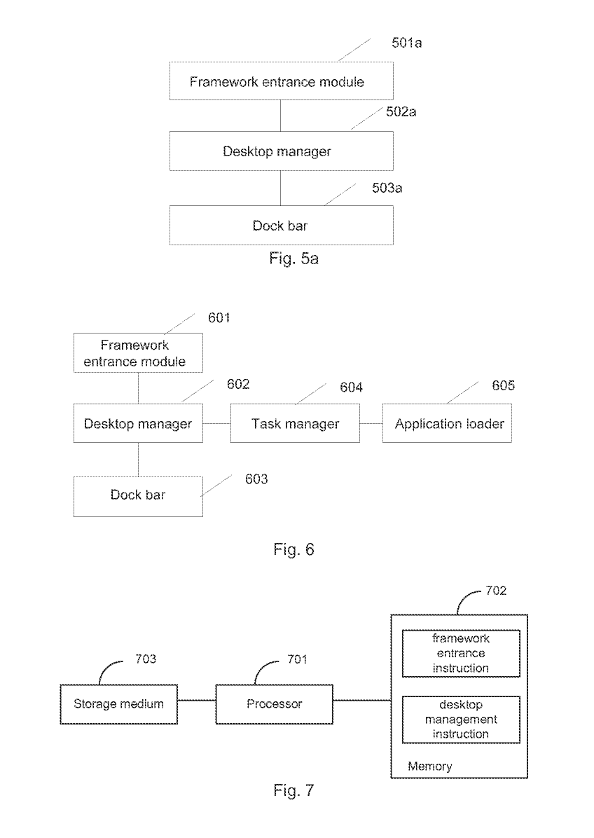

FIG. 5 is a schematic diagram illustrating structure of a desktop switching device in accordance with various embodiments.

The device includes a framework entrance module 501 and a desktop manager 502.

The framework entrance module 501 generates a first desktop window and configures the first desktop window according to a relevant relationship between the first desktop window and a second desktop window; and

The desktop manager 502 performs desktop switching according to a current desktop window and the relevant relationship between the first desktop window and the second desktop window.

FIG. 5a is a schematic diagram illustrating structure of a desktop switching device in accordance with various embodiments. The device includes the following modules.

A framework entrance module 501a generates a first desktop window and configures the first desktop window according to a relevant relationship between the first desktop window and a second desktop window. The relevant relationship between the first desktop window and the second desktop window may be configured by a user in the framework entrance module 501a in advance based on requirements. Preferably, the relevant relationship may be edited. For instance, the relevant relationship between the first desktop window and the second desktop window may be configured as a coordinative relationship in advance. Alternatively, the first desktop window may be configured as a sub-window of the second desktop window in advance.

In various embodiments, the relevant relationship between the first desktop window and the second desktop window may be stored in desktop management software in advance. Then, the framework entrance module 501a obtains the relevant relationship from the desktop management software and configures the first desktop window based on the relevant relationship.

A dock bar 503a detects a desktop switching trigger instruction of a user and trigger a trigger event corresponding to the desktop switching trigger instruction.

A desktop manager 502a performs desktop switching after monitoring the trigger event according to the current desktop window and the relevant relationship between the first desktop window and the second desktop window.

the framework entrance module 501a configures the first desktop window according to the relevant relationship between the first desktop window and the second desktop window. The framework entrance module 501a further configures the first desktop window and the second desktop window as coordinate desktop windows.

The framework entrance module 501a further configures the first desktop window as a top-level window and makes a configuration in which the first desktop window is on the top of the second desktop window and under an ordinary window corresponding to an application program.

Furthermore, when the framework entrance module 501a configures the first desktop window according to the relevant relationship between the first desktop window and the second desktop window, the framework entrance module 501a further configures that the first desktop window returns a MA_NOACTIVATE message when the first desktop window responds to a window message of the first desktop window. The MA_NOACTIVATE message is for indicating that when the user activates the first desktop window, the first desktop window is still under the ordinary window and cannot be activated to relocate on the top of the ordinary window.

Furthermore, when the framework entrance module 501a configures the first desktop window according to the relevant relationship between the first desktop window and the second desktop window, the framework entrance module 501a further configures that all sub-controls on the first desktop window are drawn and non-windows. Therefore, when the user activates a sub-control of the first desktop window, the first desktop window is still under the ordinary window and cannot be activated to relocate on the top of the ordinary window.

Furthermore, when the framework entrance module 501a configures the first desktop window according to the relevant relationship between the first desktop window and the second desktop window, the framework entrance module 501a further removes a title attribute of the first desktop window, keeps a window client area of the first desktop window, adds a tool window attribute to the first desktop window, removes display of a window taskbar of the first desktop window and configures the size of the first desktop window as that of a screen.

The desktop manager 502a captures a first desktop screenshot and a second desktop screenshot after the trigger event is monitored, combines the first desktop screenshot and the second desktop screenshot to form a screenshot, determines whether the current desktop window is the second desktop window, makes the second desktop disappear in an animation mode or a window desalination mode, displays the first desktop window in the animation mode or a window pop-up mode if the current desktop window is the second desktop window; otherwise, makes the first desktop window disappear in the animation mode or the window desalination mode and displays the second desktop window in the animation mode or the window pop-up mode.

On the other hand, when the framework entrance module 501a configures the first desktop window according to the relevant relationship between the first desktop window and the second desktop window, the framework entrance module 501a configures the first desktop window as a sub-window of the second desktop window.

The framework entrance module 501a further finds the second desktop window and takes the first desktop window as the sub-window of the second desktop window.

When the framework entrance module 501a configures the first desktop window as the sub-window of the second desktop window, the framework entrance module 501a takes the first desktop window as the sub-window of the second desktop window via a handle of the second desktop window.

The desktop manager 502a determines whether the current desktop window is the second desktop window after the trigger event is monitored and displays the first desktop window on the top of the second desktop window if yes, determines whether the current desktop window is the first desktop window, hides the first desktop window if the current desktop window is the first desktop window and displays the second desktop window.

FIG. 6 is a schematic diagram illustrating structure of a desktop switching device in accordance with various embodiments. Compared with FIG. 5a, the device further includes a task manager 604 and application loader 605.

After the desktop switching is performed and the first desktop window is displayed, the dock bar 603 detects an instruction of a user for triggering an application in the first desktop window and triggers a corresponding application trigger event.

After detecting the application trigger event, the desktop manager 602 runs the application via calling the task manager 604 with an ID of the application.

The task manager 604 queries whether the application has run according to the ID of the application, loads the application if yes; otherwise, loads the application via calling the application loader 605 with the ID of the application.

When the application is loaded, the application loader 605 searches for a code file corresponding to the application according to the ID of the application and loads the code file.

FIG. 7 is a schematic diagram illustrating another structure of the desktop switching device in accordance with various embodiments.

The desktop switching device includes a processor 701, a memory 702 and a storage medium 703.

The memory 702 stores a framework entrance instruction and a desktop management instruction.

The storage media 703 stores a relevant relationship between a first desktop window and a second desktop window.

The processor 701 executes the framework entrance instruction to generate the first desktop window and configures the first desktop window according to the relevant relationship between the first desktop window and the second desktop window in the storage medium 703; and executes the desktop management instruction to perform desktop switching according to a current desktop window and the relevant relationship between the first desktop window and the second desktop window.

The memory 702 further stores a dock bar instruction. The processor 701 further executes the dock bar instruction to detect a desktop switching trigger instruction of a user and trigger a trigger event corresponding to the desktop switching trigger instruction.

The processor 701 further executes the desktop manager instruction to perform the desktop switching according to the current desktop window and the relevant relationship between the first desktop window and the second desktop window after monitoring the trigger event.

The processor 701 further executes the framework entrance module to:

configure that the first desktop window and the second desktop window are coordinative desktop windows;

configure the first desktop window as a top-level window;

configure that the first desktop window covers the second desktop window and is under an ordinary window corresponding to an application program;

configure that the first desktop window returns a MA_NOACTIVATE message when the first desktop window responds to a window message of the first desktop window;

configure that all sub-controls on the first desktop window are drawn and non-windows; and

remove a title attribute of the first desktop window, keep a window client area of the first desktop window, add a tool window attribute to the first desktop window, remove display of a window taskbar and configure size of the first desktop window as that of a screen window.

The processor 701 further executes the desktop manager instruction to:

capture a first desktop screenshot and a second desktop screenshot after monitoring the trigger event;

combine the first desktop screenshot and the second desktop screenshot to form a screenshot;

determine whether the current desktop window is the second desktop window;

make the second desktop disappear in an animation mode and display the first desktop window if the current desktop window is the second desktop window; or

determine whether the current desktop window is the first desktop window; and

make the first desktop window disappear in the animation mode and display the second desktop window if the current desktop window is the first desktop window.

The processor 701 further executes the framework entrance instruction to

configure that the first desktop window is a sub-window of the second desktop window;

find the second desktop window; and

take the first desktop window as the sub-window of the second desktop window.

The processor 701 further executes the framework entrance module to:

take the first desktop window as the sub-window of the second desktop window via a handle of the second desktop window.

The processor 701 further executes the desktop management instruction to:

determine whether the current desktop window is the second desktop window after monitoring the trigger event;

display the first desktop window on the top of the second desktop window if the current desktop window is the second desktop window; or

determine whether the current desktop window is the first desktop window;

hide the first desktop window and display the second desktop window if the current desktop window is the first desktop window.

The memory 702 further stores a task management instruction and an application loader instruction.

The processor 701 further

executes the dock bar instruction to detect an instruction of the user for triggering an application in the first desktop window and trigger an application trigger event;

executes the desktop management instruction to run the application by calling the task management instruction with an ID of the application after the desktop management instruction detects the application trigger event;

executes the task management instruction to query whether the application has run according to the ID of the application and load the application via calling the application loader instruction with the ID of the application if the application has not run; and

executes the application loader instruction to find a code file corresponding to the ID of the application when the application is loaded and load the code file.

Various embodiments further provide a non-transitory computer-readable medium storing instructions which, when executed by one or more processors, executes steps in the above methods.

Various embodiments of the device and various embodiments of the method are based on the same idea. Refer to the various embodiments of the method for the implementation process of the device.

In various embodiments, the first desktop window is generated, the first desktop window is configured according to the relevant relationship between the first desktop window and the second desktop window, the desktop switching trigger instruction of the user is detected, the trigger event is triggered according to the desktop switching trigger instruction and the desktop switching is performed according to the current desktop window and the relevant relationship between the first desktop window and the second desktop window. Therefore, the switching between the two desktop windows is implemented, the user may select a suitable desktop according to his/her requirements and use the applications in the desktop.

It can be understood by one with ordinary skill in the art that all or partial of the above various embodiments may be implemented via hardware and may also be implemented via the hardware instructed by the program. The program may be stored in a computer readable storage media. The storage media may be a Read-Only Memory (ROM), disk or a CD, etc.

Furthermore, all or partial blocks in the above various embodiments may be implemented with a network system including network nodes. The network system may adequately utilize advantages of the hardware environment of a client and a server and rationally allocate tasks to the client and the server to reduce costs of the system communication. The client may be a thin client. The thin client may be a computer terminal which basically does not need any program in the client-server network system. Furthermore, the thin client may communicate with the server via some common communication protocols to access a LAN.

Each embodiment may be implemented by executing a data processing program with a data processing data, such a computer. The technical scheme of the present disclosure is formed by executing the data processing program. Furthermore, the data processing program in a storage media is executed by reading the program from the storage, installing the program in or copying the program to the storage device (such as hardware or memory) of the data processing data. Therefore, the storage media forms the technical scheme of the present disclosure. The storage media may be a recording mode of any type, such as a paper storage media (such as a paper tape), a magnetic storage media (such as a floppy disk, a hard disk, or a flash memory), an optical storage media (such as a CD-ROM), or a magnetic and optical storage media (such as a Magnet-Optical disk).

Furthermore, the present disclosure further provides a storage media, storing the data processing program. The data processing program is for executing any embodiment in the above methods of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A desktop switching method, comprising:
generating a first desktop window;
configuring the first desktop window according to a relevant relationship between the first desktop window and a second desktop window; and
performing desktop switching according to a current desktop window and the relevant relationship between the first desktop window and the second desktop window.

2. The method according to claim 1, further comprising:
detecting a desktop switching trigger instruction of a user;
triggering a trigger event corresponding to the desktop switching trigger instruction;
performing the desktop switching according to the current desktop window and the relevant relationship between the first desktop window and the second desktop window after monitoring the trigger event.

3. The method according to claim 2, wherein the relevant relationship between the first desktop window and the second desktop window is that the first desktop window and the second desktop window are coordinative desktop windows;
wherein configuring the first desktop window according to the relevant relationship between the first desktop window and the second desktop window comprises:
configuring the first desktop window as a top-level window;
configuring that the first desktop window covers the second desktop window and is under an ordinary window corresponding to an application program.

4. The method according to claim 3, further comprising:
configuring that the first desktop window returns a MA_NOACTIVATE message when the first desktop window responds to a window message of the first desktop window.

5. The method according to claim 3, further comprising:
configuring that all sub-controls on the first desktop window are drawn and non-windows.

6. The method according to claim 3, further comprising:
removing a title attribute of the first desktop window, keeping a window client area of the first desktop window, adding a tool window attribute to the first desktop window, removing display of a window taskbar of the first desktop window and configuring size of the first desktop window as that of a screen window.

7. The method according to claim 2, wherein performing the desktop switching according to the current desktop window and the relevant relationship between the first desktop window and the second desktop window after monitoring the trigger event comprises:
capturing a first desktop screenshot and a second desktop screenshot after monitoring the trigger event;
combining the first desktop screenshot and the second desktop screenshot to form a screenshot;
determining whether the current desktop window is the second desktop;
making the second desktop disappear in an animation mode and displaying the first desktop on the first desktop window if the current desktop window is the second desktop; or
determining whether the current desktop window is the first desktop;
making the first desktop disappear in the animation mode and displaying the second desktop on the second desktop window if the current desktop window is the first desktop.

8. The method according to claim 2, wherein the relevant relationship between the first desktop window and the second desktop window is that the first desktop window is a sub-window of the second desktop;
wherein configuring the first desktop window according to the relevant relationship between the first desktop window and the second desktop window comprises:
finding the second desktop window; and
taking the first desktop window as the sub-window of the second desktop window.

9. The method according to claim 8, wherein taking the first desktop window as the sub-window of the second desktop window comprises:
taking the first desktop window as the sub-window of the second desktop window via a handle of the second desktop window.

10. The method according to claim 9, wherein performing the desktop switching according to the current desktop window and the relevant relationship between the first desktop window and the second desktop window after monitoring the trigger event comprises:
determining whether the current desktop window is the second desktop window after monitoring the trigger event;
displaying the first desktop window on the top of the second desktop window if the current desktop window is the second desktop window; or
determining whether the current desktop window is the first desktop window;
hiding the first desktop window and displaying the second desktop window if the current desktop window is the first desktop window.

11. The method according to claim 2, further comprising:
detecting, by a dock bar, an instruction of the user for triggering an application in the first desktop window and triggering an application trigger event;
running, by a desktop manager, the application by calling a task manager with an ID of the application after the desktop manager detects the application trigger event;
querying, by the task manager, whether the application has run according to the ID of the application and loading the application via calling an application loader with the ID of the application if the application has not been run; and
finding, by the application loader, a code file corresponding to the ID of the application when the application is loaded and loading the code file.

12. A desktop switching device, comprising:
a framework entrance module, to generate a first desktop window and configure the first desktop window according to a relevant relationship between the first desktop window and a second desktop window; and
a desktop manager, to perform desktop switching according to a current desktop window and the relevant relationship between the first desktop window and the second desktop window.

13. The device according to claim 12, wherein the device further comprises:
a dock bar, to detect a desktop switching trigger instruction of a user and trigger a trigger event corresponding to the desktop switching trigger instruction; and
the desktop manager is further to perform the desktop switching according to the current desktop window and the relevant relationship between the first desktop window and the second desktop window after monitoring the trigger event.

14. The device according to claim 13, wherein the framework entrance module further configures that the first desktop window and the second desktop window are coordinative desktop windows;
the framework entrance module further
configures the first desktop window as a top-level window;
configures that the first desktop window covers the second desktop window and is under an ordinary window corresponding to an application program;
configures that the first desktop window returns a MA_NOACTIVATE message when the first desktop window responds to a window message of the first desktop window;
configures that all sub-controls on the first desktop window are drawn and non-windows; and
removes a title attribute of the first desktop window, keep a window client area of the first desktop window, add a tool window attribute to the first desktop window, remove display of a window taskbar and configure size of the first desktop window as that of a screen window.

15. The device according to claim 14, wherein the desktop manager:
captures a first desktop screenshot and a second desktop screenshot after monitoring the trigger event;
combines the first desktop screenshot and the second desktop screenshot to form a screenshot;
determines whether the current desktop window is the second desktop window;
makes the second desktop disappear in an animation mode and display the first desktop window if the current desktop window is the second desktop window; or
determines whether the current desktop window is the first desktop window;
makes the first desktop window disappear in the animation mode and display the second desktop window if the current desktop window is the first desktop window.

16. The device according to claim 13, wherein the framework entrance module configures that the first desktop window is a sub-window of the second desktop window;
the framework entrance module further:
finds the second desktop window; and
takes the first desktop window as the sub-window of the second desktop window.

17. The device according to claim 16, wherein the framework entrance module further
takes the first desktop window as the sub-window of the second desktop window via a handle of the second desktop window.

18. The device according to claim 16, wherein the desktop manager further
determines whether the current desktop window is the second desktop window after monitoring the trigger event;
displays the first desktop window on the top of the second desktop window if the current desktop window is the second desktop window; or
determines whether the current desktop window is the first desktop window;
hides the first desktop window and display the second desktop window if the current desktop window is the first desktop window.

19. The device according to claim 13, further comprising: a task manager and an application loader; wherein
the dock bar detects an instruction of the user for triggering an application in the first desktop window and trigger an application trigger event;
the desktop manager runs the application by calling a task manager with an ID of the application after the desktop manager detects the application trigger event;
the task manager queries whether the application has run according to the ID of the application and loads the application via calling an application loader with the ID of the application if the application has not run; and
the application loader finds a code file corresponding to the ID of the application when the application is loaded and loads the code file.

20. A non-transitory computer-readable medium storing instructions which, when executed by one or more processors, executes steps in claim 1.
